(19) United States
(12) Patent Application Publication
(10) Pub. No.: US 2017/0056987 A1
(43) Pub. Date: Mar. 2, 2017

(54) DUAL ACTUATION PORTABLE SAW APPARATUS

(71) Applicant: George B. Kingsley, III, Houston, TX (US)

(72) Inventor: George B. Kingsley, III, Houston, TX (US)

(21) Appl. No.: 15/253,338

(22) Filed: Aug. 31, 2016

Related U.S. Application Data
(60) Provisional application No. 62/212,123, filed on Aug. 31, 2015.

(51) Int. Cl. B23D 45/16

(52) U.S. Cl. CPC B23D 45/16

(57) ABSTRACT

The disclosure provides a dual actuation portable saw apparatus.

### CROSS-REFERENCE TO RELATED APPLICATIONS

This application claims priority to Provisional Patent Application No. 62/212,123, filed Aug. 31, 2015, which is hereby incorporated by reference in its entirety.

### FIELD OF THE INVENTION

The present disclosure relates to a portable saw apparatus, more specifically a motorized portable saw usable via the actuation of at least two actuators.

### BACKGROUND OF THE INVENTION

Accidents are a common occurrence with individuals that work with power tools. Some of the more gruesome injuries result from individuals using saw devices. Current setups of saw devices do not allow for a quick enough stoppage of the blade, resulting in large cuts and lost appendages. Additionally, many saw devices do not provide adequate protection to the individuals using the saw devices.

The disclosed subject matter provides a portable saw apparatus. The apparatus may comprise a motorized portion that may be activated via at least two actuators.

### BRIEF SUMMARY OF THE INVENTION

The disclosed subject matter provides a dual actuation portable saw apparatus. The portable saw apparatus may comprise a housing. The housing may partially or fully envelop at least one portion of at least one element of the apparatus. An upper guard may be coupled to the housing via means such as, but not limited to screw elements, clamping devices, male/female engagement, etc. A lower guard may additionally be coupled to the housing via means such as, but not limited to screw elements, clamping devices, male/female engagement, etc. A motor may be situated within the housing and may power electronic components within the apparatus. In embodiments, the motor may be releasably affixable to the housing. In embodiments, the motor may not be affixed to the housing.

A base plate may be releasably affixable to at least one of the housing and the guard. In embodiments, the base plate may be affixed to the housing and/or the guard by means similar to how the guard may be affixed to the housing.

The apparatus may further comprise a circular saw blade that may be laterally positioned within the guard. The circular saw blade may be rotatably affixed to a rotational axis. In embodiments, rotational axis may be circumnavigated by a bearing element that may allow the saw to rotate. In embodiments, at least one of the first actuation portion and the second actuation portion may be positioned facing away from the apparatus.

In embodiments, at least one of the first actuation portion and the second actuation portion may be a button. The button may be configured to be actuated by the hands of an individual. In embodiments, the first actuation portion and the second actuation portion may require dual engagement by two hands of a user. Once both actuation portions are engaged, the apparatus may be supplied power from the motor. Once at least one of the actuation portions are not engaged, the apparatus may no longer receive power from the motor.

### BRIEF DESCRIPTION OF THE DRAWINGS

The novel features believed characteristic of the disclosed subject matter will be set forth in any claims that are filed. The disclosed subject matter itself, however, further objectives, and advantages thereof, will best be understood by reference to the following detailed description of an illustrative embodiment when read in conjunction with the accompanying drawings, wherein:

FIG. 1 displays a perspective view of a portable saw apparatus in accordance with embodiments.

FIG. 2 displays a deconstructed view of a portable saw apparatus in accordance with embodiments.

FIG. 3 displays a deconstructed view of a handle of a portable saw apparatus in accordance with embodiments.

FIG. 4 displays an interior view of a handle of a portable saw apparatus in accordance with embodiments.

FIG. 5 displays a perspective view of various shaped handle and actuation portions in accordance with embodiments.

### DETAILED DESCRIPTION OF ILLUSTRATIVE EMBODIMENTS

Reference now should be made to the drawings, in which the same reference numbers are used throughout the different figures to designate the same components.

It will be understood that, although the terms first, second, third, etc. may be used herein to describe various elements, these elements should not be limited by these terms. These terms are only used to distinguish one element from another element. Thus, a first element discussed below could be termed a second element without departing from the teachings of the present disclosure.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

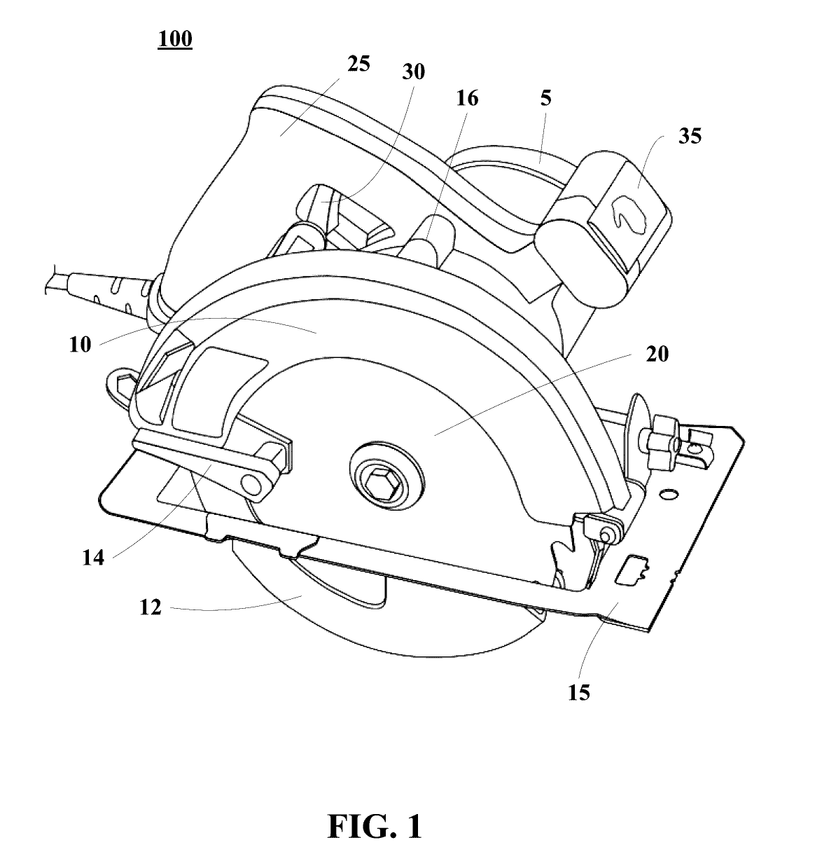

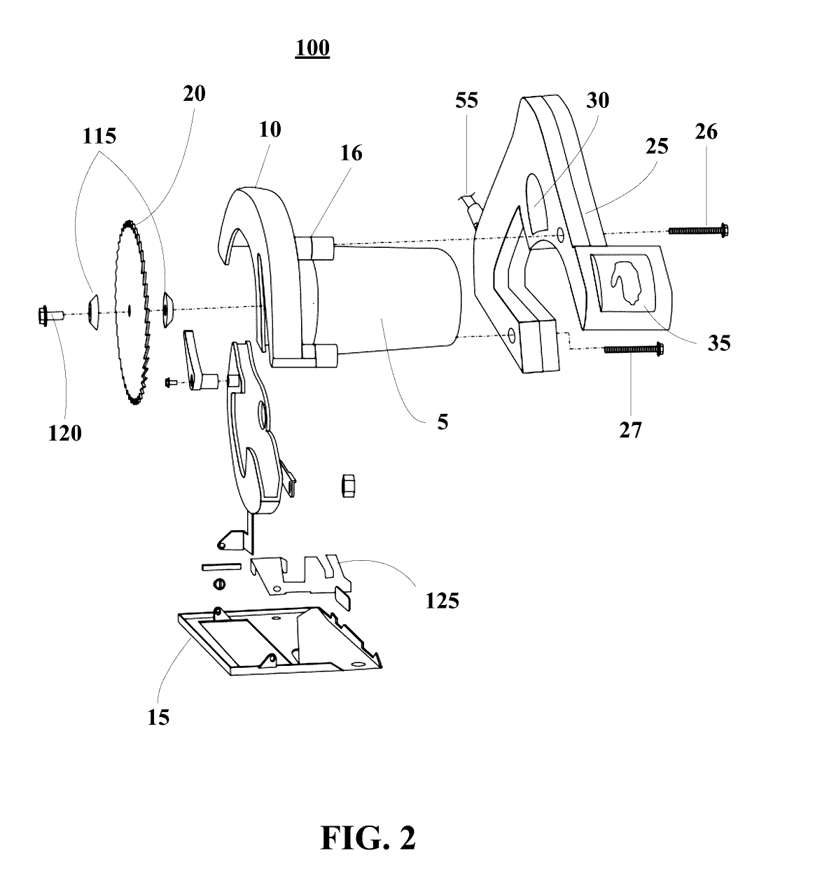

FIG. 1 displays a perspective view of a portable saw apparatus 100 in accordance with embodiments. The portable saw apparatus may comprise a housing 5. The housing 5 may partially 105 or fully envelop at least a portion of at least one element of apparatus 100. An upper guard 10 may be coupled to the housing 5 by means such as, but not limited to screw devices, clamping devices, male/female elements, etc. As shown in FIGS. 1 and 2, the upper guard 10 may be screwed to the housing 5. A lower 110 guard 12 may additionally be coupled to the housing 5 via means such as, but not limited to screw elements, clamping devices, male/female engagement, etc., so that the lower guard 12 may be in rotatable and retractable engagement with the housing 5. In order to more easily retract the lower guard 12, a lower guard 115 handle 14 affixed to a portion of the lower guard 12 may be actuated.

A motor (not shown) may be situated within the housing 5. A shaft (not depicted) longitudinally positioned within the motor may be rotated via a rotor (not depicted) found within the 120 motor. The shaft may protrude from an end of the housing 5 so that the protruding portion may be in a position to receive a screw element or similar. In embodiments, the shaft may be positioned within an orifice of the lower guard 12 so that the shaft may support the lower guard 12. In embodiments, the motor 125 may be releasably affixed to the housing 5. In embodiments, the motor may not be affixed to the housing 5.

A base plate 15 may be releasably affixed to at least one of the housing 5 and the upper guard 10. The base plate 15 may provide stability to apparatus 100 when the apparatus is in use. As apparatus 100 is used to cut a piece of wood, the base plate 15 may lay flat on the piece of wood to keep apparatus 100 from swaying. In embodiments, the base plate 15 may be affixed to the housing 5 and/or the guard 10 by means similar to the upper guard 10 affixed to the housing 5.

Apparatus 100 may further comprise a circular saw blade 20 that may be laterally positioned within the upper and lower guard 10,12. The circular saw blade 20 may be rotatably affixable around a rotational axis positioned along the shaft of the motor. In embodiments, the shaft may be circumnavigated by a 140 plurality of washers that may distribute the load of a fastener used to support the blade 20.

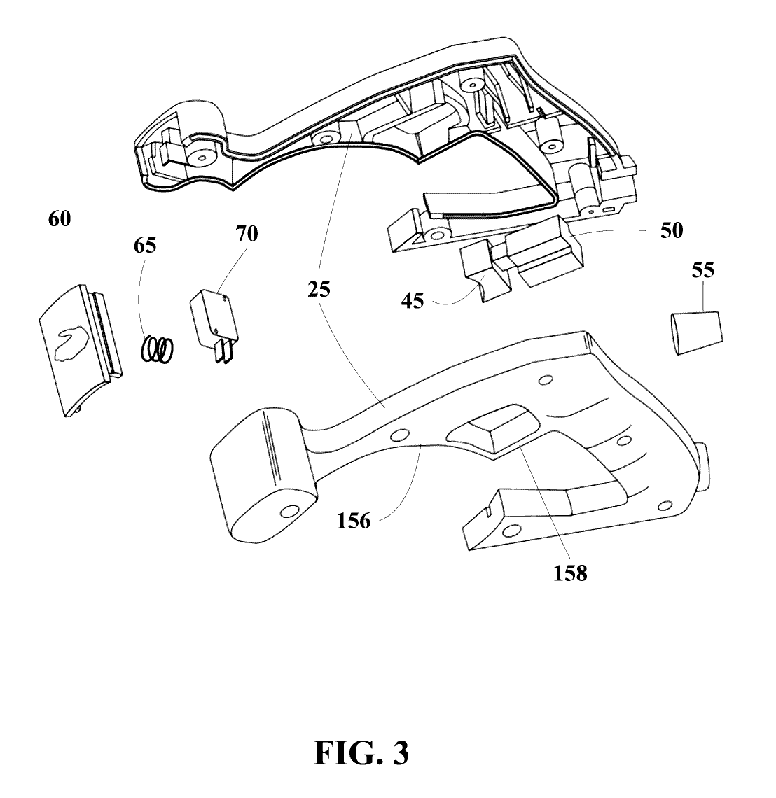

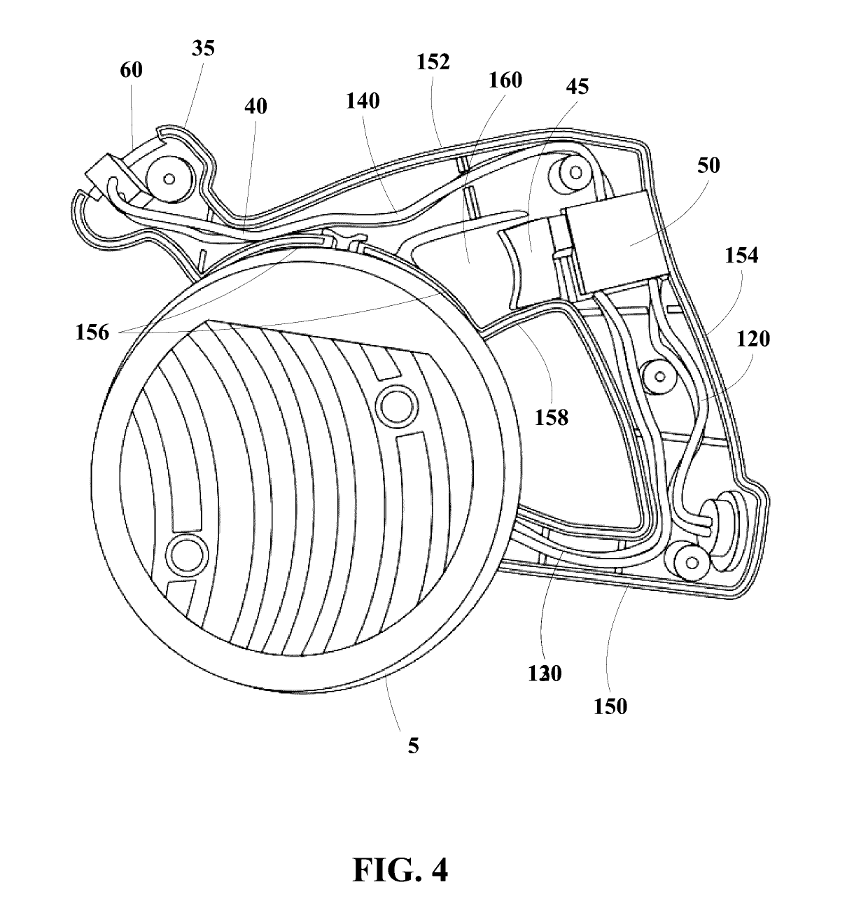

Apparatus 100 may comprise a first actuation portion 30 and a second actuation portion 35. In embodiments, at least one of the first actuation portion 30 and the second actuation 145 portion 35 may be a button 60. The button 60 may be configured to be activated by the hands of a user. In embodiments, the first actuation portion 30 and the second actuation portion 35 may require dual engagement by two hands of a user. In this scenario, the first and second actuation portions 30,35 may be integrated into a circuit 40 (FIG. 4) within the apparatus 100 via switch 70 and a switch found in a trigger base 50 (FIG. 3). Once both actuation portions 30,35 are engaged, the switches may be closed, which may complete the circuit 40 and allow the apparatus 100 to turn on. Once at least one of the actuation portions 30,35 are not engaged, the apparatus 100 may shut off due the “breaking” of the circuit. In embodiments, at least one of the first actuation portion 30 and the second actuation portion 35 may face away from the apparatus 100.

Handle portion 25 may comprise a rounded interior in order for the handle portion 25 to be seamlessly positioned on the housing 5. The handle portion 25 may be coupled to affixing point 16 consisting of a portion of the housing 5 and a portion of the upper guard 10 via a screw element (not depicted). The affixing point 16 may keep the handle portion 25 in a secure position. Additional affixing points (not depicted) may provide additional security to the handle portion 25.

In embodiments, the handle portion 25 may be affixed to the housing 5 at a fixed angle. In embodiments, the second actuation portion 35 may face away from the housing 5 at an angle perpendicular to the fixed angle. The angle of the second actuation portion 35 may provide a comfortable grip for an individual's hands as well as easy accessibility of the actuation portion 35 for the individual's hand.

It is noted that both the first actuation portion 30 and the second actuation portion 35 may be located on the handle portion 25 positioned on the housing 5, which is located on an opposite side of the apparatus 100 than the blade 20. Since a user's hands need to actuate the first and second actuation portions 30,35, the user's hands may be kept away from the blade 20, which may prevent any potential accidents.

FIG. 2 displays a deconstructed view of a portable saw apparatus 100 in accordance with embodiments. In embodiments, the apparatus 100 may comprise additional components such as, but not limited to, blade washers 115, a blade bolt 120, a base plate stabilizer section 125, etc. The blade washers 115 and bolt 120 may keep the blade 20 in place and may not allow the blade 20 to sway. The blade washers 115 may additionally distribute the load of the blade bolt 120 used to support the blade 20. The base plate stabilizer section 125 may provide stability to components found above the base plate 15. In embodiments, the components may be removably affixable to the base plate stabilizer section 125.

Affixing element 26 may affix handle portion 25 to affixing point 16, which may include portions of housing 5 and upper guard 10. In embodiments, affixing element 26 may be a screw. Affixing element 27 may affix handle portion 25 to an additional affixing point (not depicted) that may also include portions of housing 5 and upper guard 10. The affixing of the handle portion to affixing points may provide support and stability to the handle portion 25 when an individual applies force to the second actuation portion 35.

FIG. 3 displays a deconstructed view of a handle portion 25 of a portable saw apparatus 100 in accordance with embodiments. The handle portion 25 may comprise the first actuation portion 30 and the second actuation portion 35. The first actuation portion 30 and second actuation portion 35 may be at least partially positionable within handle portion 25. In that the depiction shown in FIG. 3, the first actuation portion 30 may comprise a trigger actuation configuration. A spring-loaded trigger 45 may be pushed or pulled inward toward a trigger base 50 that may internally comprise a switch mechanism. It is noted that the trigger base 50 may be positioned within the handle portion 25, while the trigger 45 may be positioned external the handle portion 25 (but affixed to the trigger base 50). When the trigger is pressed adjacent the trigger base 50, the switch mechanism may be closed so that the circuit 40 within the handle portion 25 may allow current to pass. The second actuation portion 35 may comprise a safety button 60 and safety switch 70 in springed engagement. The safety button 60 may be positioned at a top portion of the handle portion 25 just above the switch 70. A spring 65 may be positioned between the safety button 60 and the switch 70 so that when a specific amount of force is applied to the button 60, the button 60 may apply pressure to the spring 65, which may then close the switch 70. This closing of the switch 70 may allow for the completion of the circuit 40 with which the switch 70 is associated. An outlet 55 may be partially positioned within the bottom of the handle portion 25 in order to provide a covered orifice for wiring of the circuit 40 within the handle portion 25.

In embodiments, a bottom portion of the handle portion 25 may be affixed to the base plate 15 and a top portion may be affixed to the housing 5. In embodiments, the handle portion 25 may be removably affixed to elements of the apparatus by means such as, but not limited to screw devices, clamping devices, male/female elements, etc.

FIG. 4 displays an interior view of a handle portion 25 of a portable saw apparatus 100 in accordance with embodiments. A circuit 40 may be splayed within at least one of the housing 5 and the handle portion 25. A first wire portion 120 of the circuit 40 may enter the interior of the handle portion 25 through the outlet 55 and may affix to the switch within the trigger base 50. A second wire portion 130 of the circuit 40 may be affixed to the switch of the trigger base 50 and the motor. A third wire portion 140 of the circuit 40 may extend from the switch of the trigger base 50 to the second actuation portion 35. When engaged, the first and second actuation portions 30,35 may complete the circuit 40 in order to activate the motor.

In embodiments, at least one of the first wire portion 120, the second wire portion 130, and the third wire portion 140 may comprise more than one wire.

The handle portion 25 may generally comprise a bottom extension portion 150 and a top extension portion 152. The bottom extension portion 150 and the top extension portion 152 may be affixed to the bottom and top of a hand receiving portion 154. The bottom extension portion 150 may terminate at an end adjacent the housing 5. The top extension portion 152 may terminate at the second actuation portion 35 configured to receive an individual's hand. A rounded extension 156 (see also FIG. 3) may extend from the second actuation portion 35 to a protrusion portion 158 (see also FIG. 3) extending from the hand receiving portion 154. Collectively, the rounded extension 156 and the protrusion portion 158 may create a first actuation space 160 where the first actuation portion 30 may be positioned. In embodiments, the rounded extension 156 may define a side border of the first actuation space 160. In embodiments, the protrusion portion 158 may define a lower border of the first actuation space 160 and may provide space for lateral movement of the first actuation portion 30.

In embodiments, the second actuation portion 35 may comprise a button 60 engageable to close a portion of the circuit 40. In embodiments, the face of the button 60 may be offset a defined distance from the housing 5 of the apparatus 100. In embodiments, the face of the button 60 may be parallel to a tangent of the housing 50 of the apparatus 100.

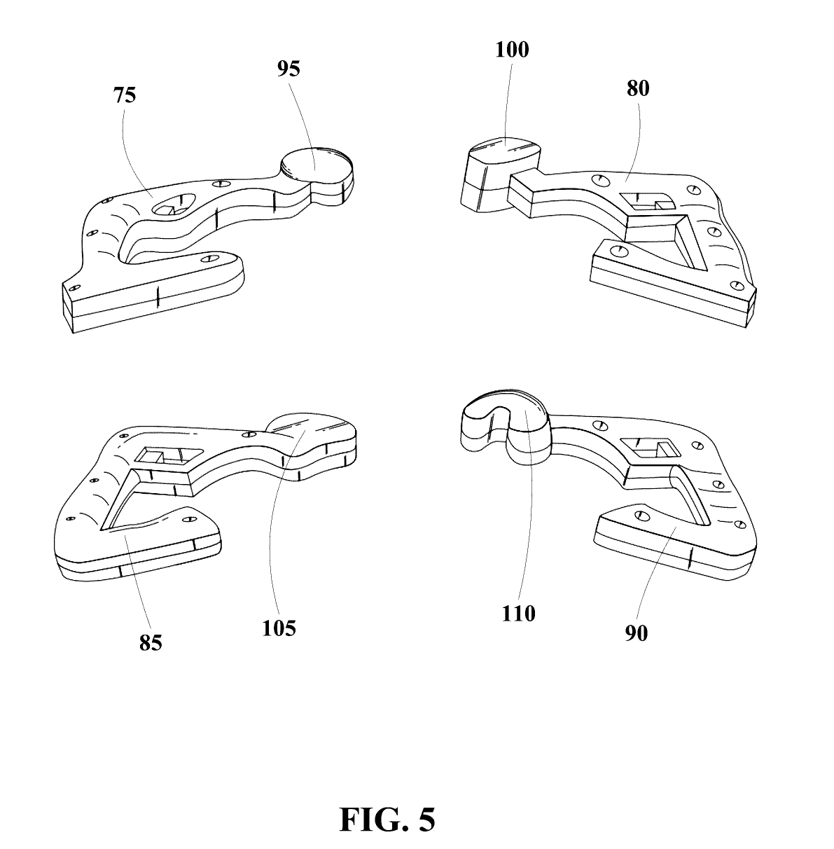

FIG. 5 displays a perspective view of various shaped handle portions 25 in accordance with embodiments. A first actuation portion 30 in all displayed embodiments of the handle portions 75,80,85,90 in FIG. 5 may comprise a grip, such as, but not limited to, a trigger grip. A rounded grip 95 of the second actuation portion 35 of a first handle portion 75 may be ovular in shape and may be wide enough to provide comfort for a user's hand, specifically a user's palm. T second handle portion 80 of the second actuation portion 35 may comprise a trapezoidal grip 100. The trapezoidal grip 100 may also provide a wide area to support a user's palm comfortably and may additionally provide a portion for a user's fingers to grip comfortably. The second actuation portion 35 of a third handle portion 85 may comprise a thin grip 105 terminating at a rounded point. The thin grip 105 may allow a user's fingers to be placed comfortably adjacent the grip 105 with one finger comfortably resting on top of the thin grip 105 for easy actuation of the second actuation portion 35. The second actuation portion 35 of a fourth handle portion 90 may comprise a curved retaining grip 110. The curved retaining grip 110 may allow a user's fingers to curl around the grip 110. The user may therefore have a more secure grip due to the curved grip 110 and may provide additional leverage to actuate the second actuation portion 35 when an individual's fingers are retained within the curved retaining grip 110. In embodiments, a first and/or second actuation portion 30,35 may comprise a grip different than those described above.

In embodiments, the button 60 may comprise different configurations based on the grip to which it is affixed. For example, the button 60 may have a different configuration if it is affixed to the rounded grip 95, the trapezoidal grip 100, the thin grip 105, and the curved retaining grip 110. In embodiments, more than one grip 95,100,105,110 may comprise a similarly configured button 60.

In embodiments, the power source may be the motor. This may be possible if the motor is dependent on its own internal power source, which may include sources such as, but not limited to, batteries. It is noted that the motor may include one or more components of a standard motor found within a circular saw unless otherwise described.

In embodiments, the first actuation portion 30 and the second actuation portion 35 may be aligned along an actuation plane parallel to the circular saw blade rotational axis along the handle portion.

In embodiments, at least one of the first actuation portion 30 and the second actuation portion 35 may be aligned perpendicular to the circular saw blade 20 rotational axis. In embodiments, at least one of the first actuation portion 30 and the second actuation portion 35 may be aligned parallel to the circular saw blade 20 rotational axis. In embodiments, at least one of the actuation motions of the first and second actuation portions 30,35 may be perpendicular to the circular saw blade 20 rotational axis.

In embodiments, at least one of the first actuation portion 30 and the second actuation portion 35 may be larger in width than at least another portion of the handle portion 25. In embodiments, at least one of the first actuation portion 30 and the second actuation portion 35 may be large enough in width to provide a comfortable base for a user's palm to be placed.

In embodiments, the second actuation portion 35 may include the button 60 as well as the topmost portion of the handle portion 25 (such as the rounded grip 95, the trapezoidal grip 100, the thin grip 105, and the curved retaining grip 110).

In embodiments, the first actuation portion 30 may include the trigger 45 and the trigger base 50.

In embodiments, the face of the button 60 may be offset a defined distance from the housing 5 of the apparatus 100.

While this disclosure has been particularly shown and described with reference to preferred embodiments thereof and to the accompanying drawings, it will be understood by those skilled in the art that various changes in form and details may be made therein without departing from the spirit of this disclosure. Therefore, the scope of the disclosure is defined not by the detailed description but by the appended claims.

1. A portable saw apparatus comprising:
a housing;
an upper guard coupled to the housing;
a lower guard coupled to the housing;
a motor situated within the housing;
a base plate releasably affixed to at least one of the housing and the guard;
a blade laterally positioned within the guard, the blade being rotatably affixed around a rotational axis;
a handle portion coupled to a portion of at least one of the housing and the base plate, the handle portion comprising a first actuation portion and a second actuation portion;
and
a circuit splayed within the handle, the circuit electrically connecting a power source to the first actuation portion, the second actuation portion, and the motor;
wherein the first and second actuation portions are engageable to close the circuit and activate the motor.

2. The apparatus of claim 1, at least one of the first actuation portion and the second actuation portion being a button.

3. The apparatus of claim 1, the first actuation portion and the second actuation portion requiring dual simultaneous engagement.

4. The apparatus of claim 1, at least one of the first actuation portion and the second actuation portion aligned perpendicular to the circular saw blade rotational axis.

5. The apparatus of claim 1, the first actuation portion and the second actuation portion aligned along an actuation plane parallel to the circular saw blade rotational axis.

6. The apparatus of claim 1, the handle portion affixed to the housing at a fixed angle, further wherein the second actuation portion faces away from the housing at an angle perpendicular to the fixed angle.

7. The apparatus of claim 1, at least one of the first actuation portion and the second actuation portion comprising a curved retaining grip.

8. The apparatus of claim 1, at least one of the first actuation portion and the second actuation portion being a trigger actuator.

9. The apparatus of claim 1, at least one of the first actuation portion and the second actuation portion larger in width than at least another portion of the handle portion.

10. The apparatus of claim 1, at least one of the first actuation portion and the second actuation portion comprising a button and switch in springed engagement.

11. The apparatus of claim 1, the rotational axis circumnavigated by a bearing element.

12. The apparatus of claim 1, wherein the handle portion is positioned on the housing at a defined length from the blade, the positioning allowing for an individual's hands to be positioned safely away from the blade when the motor is actuated.

13. The apparatus of claim 1, further comprising a curved retaining grip affixed to a top end of the handle portion, the curved retaining grip providing additional leverage to actuate the second actuation portion when an individual's fingers are retained within the curved retaining grip.

14. A handle apparatus affixable to a portable saw apparatus, the handle apparatus comprising:
a hand receiving portion;
a bottom extension portion affixed to a bottom of the hand receiving portion;
a top extension portion affixed to a top of the hand receiving portion;
a first actuation portion at least partially positioned within the hand receiving portion;
a protrusion portion defining a lower border of a first actuation space, the first actuation space providing space for lateral movement of the first actuation portion;
a rounded extension extending from the second actuation portion to the protrusion portion, the rounded extension defining a side border of the first actuation space;
and
a circuit splayed within the handle, the circuit electrically connecting a power source to the first actuation portion, the second actuation portion, and a motor;
wherein the first and second actuation portions are engageable to close the circuit and activate the motor.

15. The apparatus of claim 14, the second actuation portion comprising a curved retaining grip, the curved retaining grip providing additional leverage to actuate the second actuation portion when an individual's fingers are retained within the curved retaining grip.

16. The apparatus of claim 14, wherein the bottom extension portion terminates at an end adjacent a housing of the circular saw apparatus.

17. The apparatus of claim 14, wherein the top extension portion terminates at a second actuation portion configured to receive an individual's hand.

18. The apparatus of claim 14, the second actuation portion further comprising a button engageable to close a portion of the circuit.

19. The apparatus of claim 18, wherein the face of the button is offset a defined distance from a housing of the portable saw apparatus.

20. The apparatus of claim 18, wherein the face of the button is parallel to a tangent of a housing of the portable saw apparatus.
